(19) United States
(12) Patent Application Publication
(10) Pub. No.: US 2012/0066076 A1
(43) Pub. Date: Mar. 15, 2012

(54) Electronic Method of Sharing and Storing Printed Materials

(76) Inventor: Robert Michael Henson, Suwanee, GA (US)

(21) Appl. No.: 13/114,001

(22) Filed: May 23, 2011

Related U.S. Application Data
(60) Provisional application No. 61/347,459, filed on May 24, 2010.

(51) Int. Cl. G06Q 30/02; G06F 17/00

(52) U.S. Cl. 705/14.73; 715/251; 715/205

(57) ABSTRACT

Disclosed is a method of making searchable and sharable ideas found on the printed page using an electronic medium. The method includes storing and sharing with others portions of printed publications while preserving the pagination and format of the original content. The stored information is complied in an electronic database such that particular page can be retrieved. The system can assemble the requested pages and deploy them to a user account or send the same electronically to another to share and keep pages in a format and manner designed to preserve the integrity of the original publication.

### CROSS-REFERENCE TO RELATED APPLICATION

This application claims priority to U.S. Provisional Patent Application Ser. No. 61/347,459 filed May 24, 2010, the contents of which are hereby incorporated in their entirety.

### TECHNICAL FIELD

The present system provides a method for making searchable and sharable ideas found on the printed page. In greater detail the present method includes the storing and sharing with others certain portions of printed publications while preserving the pagination and format of the original content including the copyright.

Additionally, the method includes capturing and accumulating noteworthy portions of printed publications for a user's own personal knowledge base.

### BACKGROUND

When reading books, newspapers or other forms of literature or printed publications one often encounters ideas and expressions that are memorable and enriching. Sharing these ideas with others typically involves providing clippings of newspaper articles or just summarizing the ideas found therein. Additionally, one is unable to remember most of what is read. Referencing previously read materials is difficult given the number of books and articles read by users and the volume and content of such materials.

However, it would be desirable if certain thoughts and words expressed on the pages when reading could be captured and stored electronically in their original pagination or format. Additionally, it would be desirable to provide a means for accessing such information in an easily organized and searchable format.

Therefore, there exists a need for providing a means for referencing and sharing thoughts and expressions found in printed literature with others using an electronic medium. There also exists a need for capturing thoughts and expressions encountered in literature for assembling a personal knowledge base in an electronic medium.

### SUMMARY

The present method provides a system for storing and retrieving print media divided according to the page number or otherwise specified location or region within a delivered electronic document. The stored information can reside within an online database so that a particular page or region can be retrieved using a search engine deciphering a user's request for a particular page or region. The system can assemble the requested pages and deploy them to a user account or send them electronically to an authorized user so that authorized users can view, share and keep pages in a format and manner designed to preserve the integrity of the printed publication and in an embodiment copyrights therein.

In greater detail the electronic method of storing, retrieving and sharing paginated printed media comprises the step of acquiring from a printed publication an identified portion of text. The term “printed publication” includes in an embodiment electronic books or publications commonly known as electronic books (e-books). The method includes storing the identified portion of text on a computer readable medium and then retrieving the stored identified portion comprising an amalgam and displaying the same to a first user.

Additionally, the method includes the identified portion retaining the original pagination of the printed publication. The method also includes providing the amalgam to a second user authorized by the first user. The amalgam may include a hyperlink that may include a link. the printed publication and an offer to purchase the printed publication. Furthermore, the amalgam can include the footnotes of the selected portion of the printed publication.

Furthermore, the stored identified portion of the text on the computer readable medium is combined into a user library associated with the user. The user library is organized by the user according to read lists and compilations. The library is also searchable and may be organized by such identifiers selected as authorship, material available by the same author, ratings and combinations thereof.

A further embodiment of the electronic method of storing, retrieving and sharing paginated printed media includes the steps of acquiring from a printed publication an identified portion of text. The method further includes storing the identified portion of text on a computer readable medium within a user library and wherein the identified portion retains an original pagination of the printed publication. Additionally, the method includes retrieving the stored identified portion comprising an amalgam and displaying the same to a second user authorized by a first user.

An additional embodiment includes an electronic method of storing, retrieving and sharing paginated printed media including the steps of acquiring from a printed publication an identified portion of text and storing the identified portion of text on a computer readable medium within a user library. The user library may be organized by the user according to read lists and compilations and wherein the identified portion retains an original pagination of the printed publication. The method further includes retrieving the stored identified portion comprising an amalgam and the displaying the same to a first user. The amalgam includes a hyperlink to the printed publication and an offer to purchase the printed publication.

### DRAWINGS

In the Drawings:

FIG. 1 depicts an embodiment illustrating a page view of an amalgam of the method showing a quick search feature;

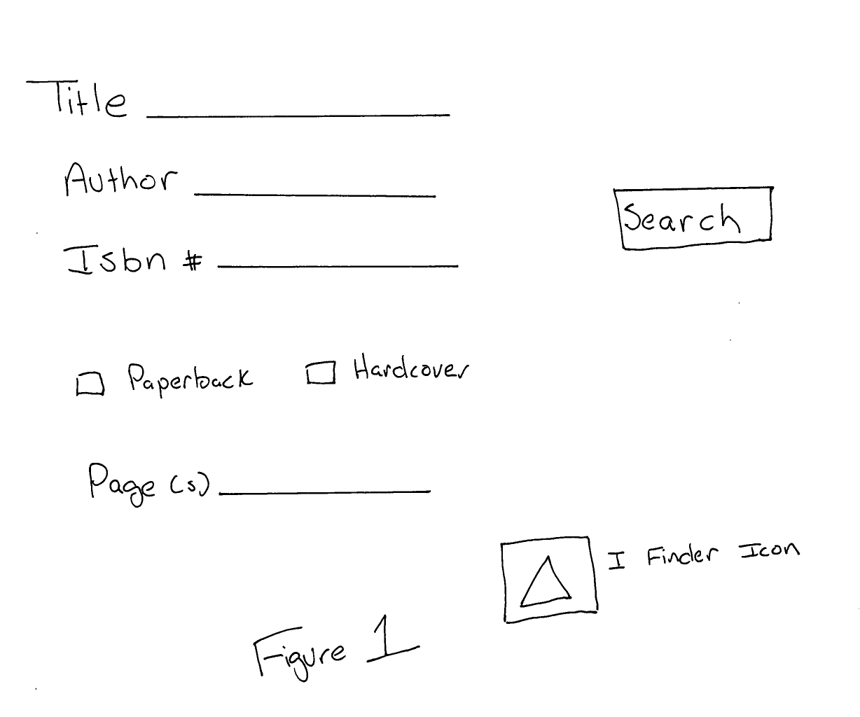

FIG. 2 further depicts a page view illustrating a detailed organizational view presented in the present method; and

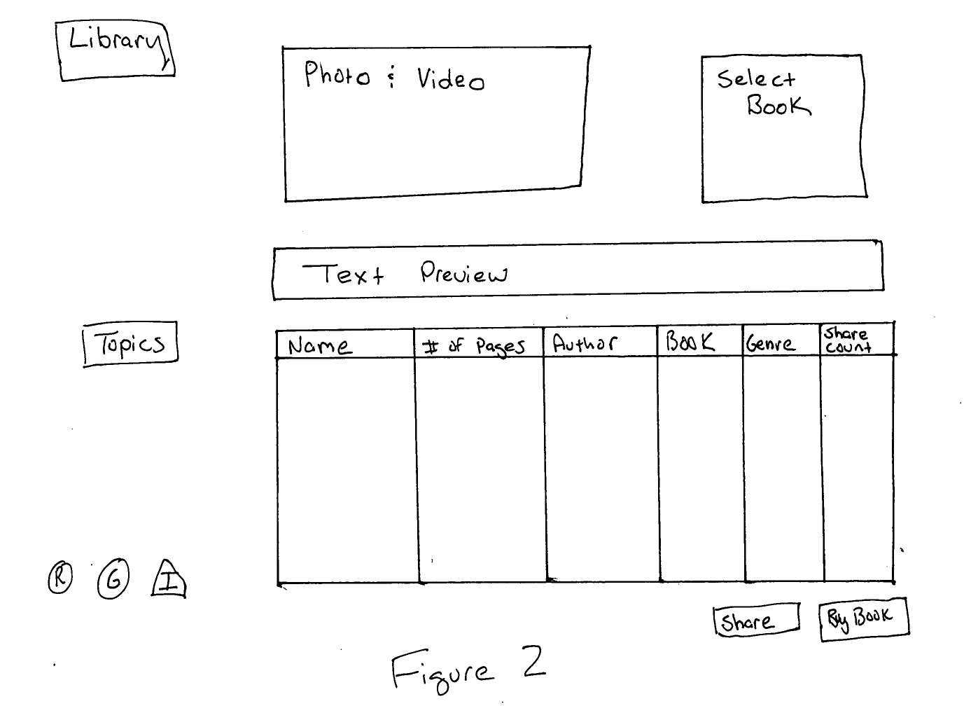

FIG. 3 illustrates a page view of a book track with various options of sharing contents of the printed publication in the amalgam.

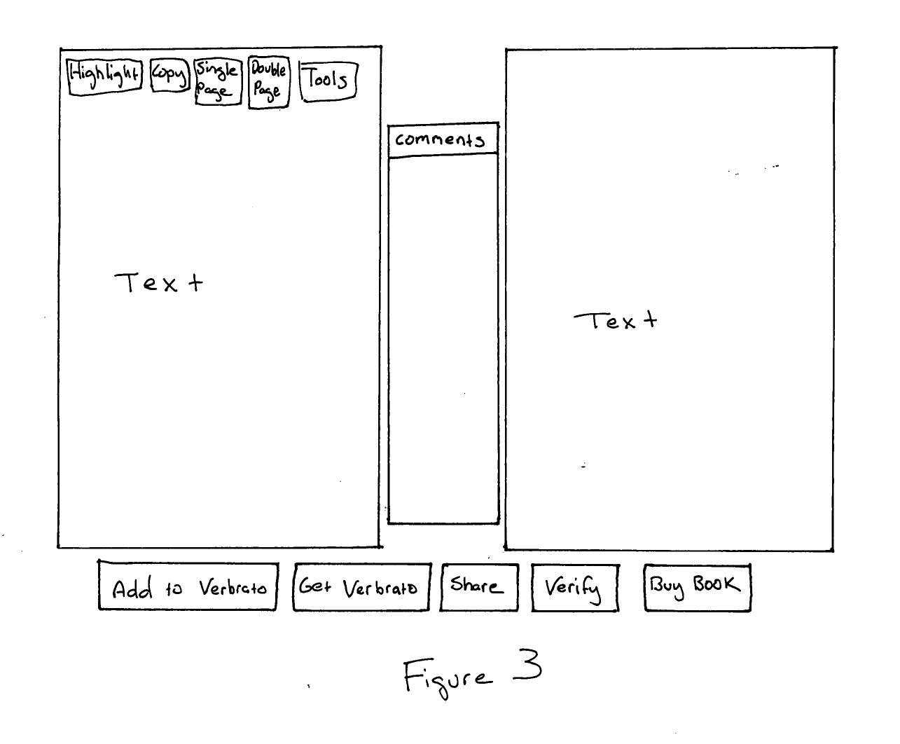

### DETAILED DESCRIPTION

Disclosed is a method of making searchable and sharable ideas found on the printed page using an electronic medium. The method includes in an embodiment the storing and sharing with others portions of printed publications while preserving the pagination and format of the original content. The stored information is compiled in an electronic database so that a particular page can be retrieved using a search engine deciphering a user request for a particular page. The system can assemble the requested pages and deploy them to a user account or send them electronically to an authorized user to share and keep pages in a format and manner designed to preserve the integrity of the original printed publication and in an embodiment copyrights therein.

The term “printed publication” includes both physical publications and in an embodiment electronic publications from such sources by way of example and not limitation as electronic books. In electronic books there may be links inserted into footnotes so that sited authors and sources noted can be easily researched.

### The Dividing and Deposit Process

The system divides an electronic document or file into individual pages and assigns unique identifiers to each page. The system deposits the pages into a database and organizes the files according to the unique identifiers.

### The Search and Amalgamation Process

The system search tool interacts with the database to find the page or region files with the unique identifiers requested by the user either by manual input or by an automated process.

In the manual embodiment, the user may input an ISBN number plus the page number or numbers desired to be captured. The user may also input the author, title or publication date of the particular reference. This methodology is used in the divide and deposit process for storing and organizing the individual pages in the database.

In the automated embodiment, the system allows for information to be transferred from a trusted online source directly to a user account. The automated embodiment includes that upon the purchase of a book or magazine from the trusted online source, the information about the purchased or otherwise obtained material is automatically populated in the library of the user. This enables the user to quickly obtain amalgams by merely indicating the page number(s) they are requesting from a particular book, magazine, or other printed matter. Additionally, in an embodiment, the method also enables the user to obtain articles or other noteworthy text found on websites, an amalgam and store it in the user account library for later use.

In either embodiment, the search tool finds the requested page or pages and assembles them to create the amalgam, which is then deposited into the user's library.

### Amalgam as an Information Gatherer

The amalgam has embedded within properties which facilitate the protecting of the integrity of the text and legal rights to it, the amalgam also spreads awareness of the content source through distribution of the amalgam. But as an entity unto itself, the amalgam carries information (“tags”) as to where the amalgam originates as well as where it goes as it is shared amongst networks of people.

Therefore the amalgam, when shared, becomes a useful tool for gathering information so that publishers and booksellers can learn buying/reading habits of people who use the system.

### Amalgam as a Marketing Tool

The amalgam (mixture or combination) can be attached to an email, posted as a link or embedded on a website, wherein such can be used for the purpose of sharing. The frame around the amalgam houses a number of buttons the may be clicked on to enable a variety of features. The features may include by way of example “Buy Now”, “Highlighting”, “Link to Source” and “Enhanced View” modes. Most notably, after reading the page in the amalgam, the recipient has the opportunity to click the “Buy Now” link and be directed to an internet store where the book or other forms of media can be purchased or acquired.

Therefore the amalgam is useful as a marketing tool as it is, by design, a sample of the product being sold and also a vehicle whereby the prospect can quickly and easily be directed to the place of purchase.

### The System Website

When logged into a user account or library, the user can utilize an organizational interface where the user can arrange content including amalgams in various read lists and compilations. The search tool is available for retrieving amalgams. Information pertaining to the content, including items such as the amalgam or master book file is displayed by such identifiers as authorship, material available by the same author, ratings, how many amalgams have been downloaded, original source and the like.

### Link to Original Source

When accessed in the system's user account, the amalgam frame houses an additional button which is the “link to the original source” icon button which is, in effect, a Bookmark attributed to the saved content. The “link to original source” icon is available in the system user account. Content saved in a system account (amalgam or otherwise) may have a hyperlink attributed to it. When a user is logged in to system (viewing/managing their content), they simply click the “link to original source” icon and are directed to the website where the content was originally obtained. This feature saves a few steps that would normally be necessary to return to the site where the content was obtained. This feature could also be included in a “Web-Article Version” of the amalgam so that upon sharing, the recipient can easily link to the source of the web article if one's interest is peaked.

Locating the bookmark (if you have saved one) where you “think” you acquired the content from originally. If you don't have the bookmark for the site, you would be forced to use your memory or conduct some other search in history or start from square one with a new Google search, for example. Therefore the “Link to Original Source” feature saves the user time by eliminating steps.

While Applicant has set forth embodiments as illustrated and described above, it is recognized that variations may be made with respect to disclosed embodiments. Therefore, while the invention has been disclosed in various forms only, it will be obvious to those skilled in the art that many additions and modifications can be made without departing from the scope of this invention, and no undue limits should be imposed except as set forth in the following claims.

What is claimed is:

1. An electronic method of storing, retrieving and sharing paginated printed media comprising the steps of:
acquiring from a printed publication an identified portion of text;
storing the identified portion of text on a computer readable medium; and
retrieving the stored identified portion comprising an amalgam and displaying the same to a first user.

2. The method of claim 1, wherein the identified portion retains an original pagination of the printed publication.

3. The method of claim 1, wherein the method includes providing the amalgam to a second user authorized by the first user.

4. The method of claim 1, wherein the amalgam includes a hyperlink.

5. The method of claim 4, wherein the hyperlink includes a link to the printed publication.

6. The method of claim 1, wherein the amalgam includes an offer to purchase the printed publication.

7. The method of claim 1, wherein amalgam includes the footnotes of the selected portion of the printed publication.

8. The method of claim 1, wherein the stored identified portion of text on the computer readable medium is combined into a user library associated the user.

9. The method of claim 8, wherein the user library is organized by the user according to read lists and compilations.

10. The method of claim 8, wherein the user library is searchable.

11. The method of claim 8, wherein the user library is organized by such identifiers selected from the group consisting of authorship, material available by the same author, ratings and combinations thereof.

12. An electronic method of storing, retrieving and sharing paginated printed media comprising the steps of:
acquiring from a printed publication an identified portion of text;
storing the identified portion of text on a computer readable medium within a user library and wherein the identified portion retains an original pagination of the printed publication; and
retrieving the stored identified portion comprising an amalgam and displaying the same to a second user authorized by a first user.

13. The method of claim 12, wherein the amalgam includes a hyperlink including a link to the printed publication.

14. The method of claim 12, wherein the amalgam includes an offer to purchase the printed publication.

15. The method of claim 12, wherein the user library is organized by the user according to read lists and compilations.

16. An electronic method of storing, retrieving and sharing paginated printed media comprising the steps of:
acquiring from a printed publication an identified portion of text;
storing the identified portion of text on a computer readable medium within a user library organized by the user according to read lists and compilations and wherein the identified portion retains an original pagination of the printed publication; and
retrieving the stored identified portion comprising an amalgam and the displaying the same to a first user, and the amalgam includes a hyperlink to the printed publication and an offer to purchase the printed publication.

17. The method of claim 16, wherein the method includes providing the amalgam to a second user authorized by the first user.

18. The method of claim 16, wherein the user library is organized by such identifiers as authorship, material available by the same author, and ratings.

19. The method of claim 16, wherein amalgam includes the footnotes of the selected portion of the printed publication.

20. The method of claim 16, wherein the user library is searchable and organizers from identifiers selected from the group of authorship, material available by the same author, ratings and combinations thereof.
